(19) United States
(12) Patent Application Publication
(10) Pub. No.: US 2020/0213315 A1
(43) Pub. Date: Jul. 2, 2020

(54) Method for Controlled Sharing of Wind Farms and Wind Turbines Data, Data Analysis Algorithms, and Results of Data Analysis

(71) Applicant: Windstack IVS, København ø (DK)

(72) Inventors: Francesco Paraggio, Eboli (IT); Andrea Paraggio, Giffoni Sei Casali (IT); Giuseppe Aceto, Frasso Telesino (IT)

(73) Assignee: Windstack IVS, København ø (DK)

(21) Appl. No.: 16/635,110

(22) PCT Filed: Jul. 30, 2018
(86) PCT No.: PCT/IB2018/055693

§ 371 Date: Jan. 29, 2020

Related U.S. Application Data
(60) Provisional application No. 62/538,732, filed on Jul. 30, 2017.

(51) Int. Cl. H04L 29/06; G06Q 50/06; G06F 16/178; G05B 19/042; F03D 17/00; F03D 7/04; H02J 3/38; H02J 13/00

(52) U.S. Cl. CPC H04L 63/10; G06Q 50/06; G06F 16/1794; G05B 19/042; H02J 2300/28; F03D 7/048; H02J 3/381; H02J 13/00006; G05B 2219/2619; F03D 17/00

(57) ABSTRACT

A method for controlled sharing of data, data analysis algorithms, and results of data analysis regarding one or a plurality of wind turbines and wind farms, and controlled access to said data, data analysis algorithms, and results of data analysis, comprising the following steps:
1. provision of sensor means for reading data relating to the operation of each wind turbine, respectively of each wind farm, of said plurality of wind turbines, respectively of wind farms, for monitoring the operating data of the wind turbines of said plurality of wind turbines, respectively of wind farms;
2. connection through a telecommunication network of a plurality of users for the sharing among them of the operating data of the wind turbines of said plurality of wind turbines, respectively of wind farms, and algorithms for processing said data;

The present invention regards a method for controlled sharing of wind farms and wind turbines data, data analysis algorithms, and results of data analysis.

### BACKGROUND

Wind energy is a growing economic sector, also benefiting from continuous research and development that is further lowering wind energy costs. Due to the rapid technical and regulatory evolution, the design, operating and planning of wind farms has become more complex. On the other side researchers to push forward the state-of-art are in need of more and more detailed and representative data from newly installed models of wind turbines together with information on the real context in which the turbines are operating.

So far, wind farm technical managers want to learn from data analysis because their choices are becoming more and more data driven, but they have to rely on a fragmented non-real-time access to data, most of the times just from the wind farms they manage. In their turn, researchers had great difficulty in obtaining high quality data from operating wind turbines. When such data is available, it can be represented in many different formats (possibly implying different precision), and be collected with different criteria (e.g. for sampling parameters). Accessing harmonized real time wind farms data would allow to improve their activities, getting insights and useful information only available by aggregating and comparing data from different wind farms; for researchers, it will enable the development of better models, experimenting with new analysis algorithms, and more extensive automation of data mining and analysis of wind turbine operational conditions.

### BRIEF SUMMARY OF THE INVENTION

A method is disclosed for controlled sharing of data, data analysis algorithms, and results of data analysis of wind farms or wind turbines.

Data items, data analysis algorithms and results of data analysis are created or entered automatically in the system by a variety of participating users. The data from the participating users are processed to form a single harmonized dataset. The data processing procedures are harmonized in form of algorithms that are uniformly characterized in a common description schema. The system allows controlled access to the dataset and the processing algorithms, and allows specification of criteria for sharing owned dataset and algorithms in specific transformed form (derived dataset or algorithm). Criteria for the creating and sharing of the derived dataset or algorithm include licensing terms, costs, and quality degradation procedures to be applied to the original dataset or algorithm to create the derived dataset. The system allows the users to search, analyze, setup notifications, alarms, control actuators and publish information, based on the users' owned dataset and derived dataset that are available to them.

The invention provides a method for controlled sharing of data, data analysis algorithms, and results of data analysis regarding one or a plurality of wind turbines and wind farms, and controlled access to said data, data analysis algorithms, and results of data analysis, comprising the following steps:
1. provision of sensor means for reading data relating to the operation of each wind turbine, respectively of each wind farm, of said plurality of wind turbines, respectively of wind farms, for monitoring the operating data of the wind turbines of said plurality of wind turbines, respectively of wind farms; note in this embodiment the sensors are existing sensors in the wind turbine or wind farms, such as for example meteorological sensors at a wind tower in the wind farm, temperature, wind velocity and rotor rotation sensors at wind turbines in the wind farm, or additional sensors that extend, complement, or reproduce for redundancy the readings from said existing sensors, with information related to each wind turbine, respectively of each wind farm, of said plurality of wind turbines, respectively of wind farms;
2. provision of data storage and management means, to store and provide controlled access to data of the wind turbines of said plurality of wind turbines, respectively of wind farms;
3. connection via point-to-point links or telecommunication network of said sensor means to said data storage and management means;
4. provision of processing and calculation means, connected with point-to-point links or telecommunication network to said data storage and management means and configured for collecting, storing, and processing of the operating data of the wind turbines of said plurality of wind turbines, respectively of wind farms;
5. provision of processing and control means, to manage data, and metadata, and brokering of all the interactions of users with the system implementing the proposed method; connected with respect to the said telecommunication networks;
6. connection through a telecommunication network of a plurality of users for the sharing among them of the operating data of the wind turbines of said plurality of wind turbines, respectively of wind farms, and algorithms for processing said data;
7. collection and storage of data derived from or related to sensors readings on wind turbines, wind farms, related devices and surroundings;
8. execution of modular shareable data processing procedures that transform input data into a single harmonized format;
9. execution of modular shareable procedures that process harmonized data to extract information regarding the operational conditions of the wind turbines or the wind farm;
10. storage in form of harmonized data of the results of the execution of the modular shareable procedures on harmonized data;
11. interaction with users of the system to allow the addition of input sources, datasets, and processing procedures (algorithms);
12. execution of procedures to apply sharing criteria and constraints for datasets and processing procedures (algorithms) among different users of the system, optionally involving the execution of quality degradation procedures on datasets and algorithms to create the shared form of datasets and algorithms;
13. execution of modular shareable procedures that process harmonized data to create a report of information extracted from harmonized data;
14. interaction with users of the system to allow controlled access to datasets and processing procedures, and the sharing criteria for datasets and processing procedures (algorithms).

According to the invention, data and results of data processing can trigger alarms, issue notifications, and command actuators; in the preferred embodiment actuators are on a wind turbine.

According to the invention, processing algorithms are suggested to the users on the basis of information related to their associated wind farms, the related datasets, and the availability of other processing algorithms and datasets. The suggestion includes or is based on the estimate of potential economic savings or gains from wind farm operations, and the estimate of potential economic savings or gains from wind farm operations is calculated based on historical data of wind farms before and after the adoption of a data processing algorithm.

According to the invention, in the preferred embodiment part or all the developed system is deployed inside a wind turbine or on the premises of a wind farm.

According to the invention, part or all the control and policy enforcement activities can be implemented with blockchain technologies, and part or all the data storage and management activities can be implemented on a distributed ledger with blockchain technologies.

According to the invention, the method can be also applied when data are derived from sensors on solar or photovoltaic plants or on run-of-river hydro power plants or on biomass power plants or on diesel, gasoline, biogas, alternative and custom fuels generators or on electric utility grids or on microturbines or on fuel cells.

According to the invention, the method can be also applied when data are derived from sensors on energy storage plants or machinery such as flywheels or battery bank or flow batteries or hydrogen plants.

According to the invention, data are associated with specifications of sharing criteria, processing algorithms, sharing criteria for processing algorithms and data, and sharing criteria can include specifications of quality degradation algorithms.

According to the invention, data can be input input in the system from databases, regardless of the input method.

According to the invention, data and results of data processing can be accessed by means of interactive, vocal, text, conversational or haptic interface.

### BRIEF DESCRIPTION OF THE DRAWINGS

For a more complete understanding of the invention, reference is made to the following description and accompanying drawings, in which:

FIG. 1 Data Flow Diagram describing the main flow of data through the system;

FIG. 2 Component Diagram showing the overall system architecture;

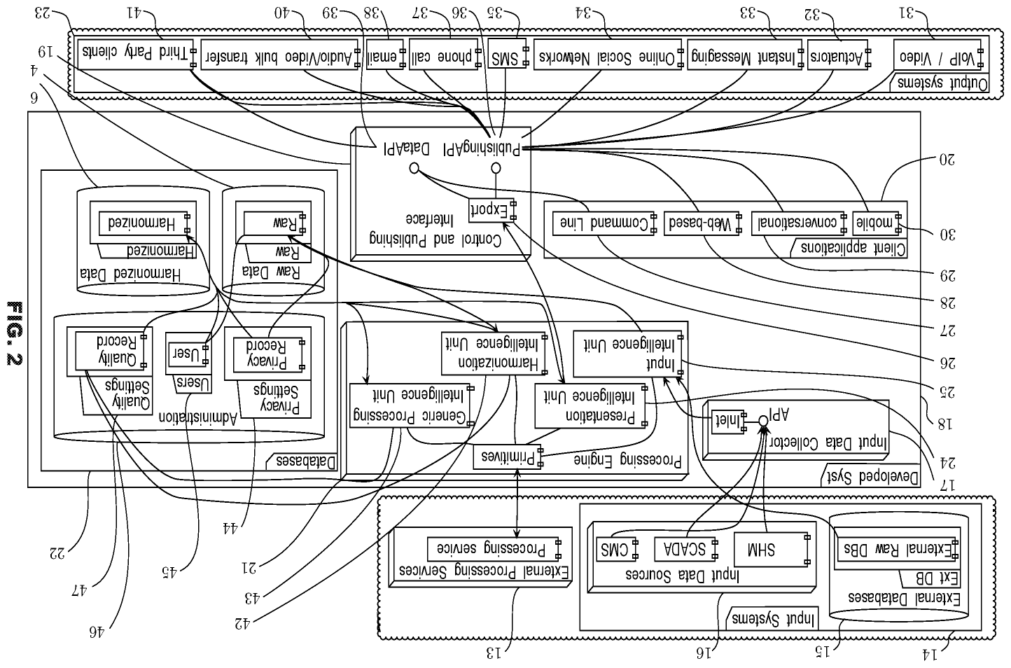

FIG. 3 Component Diagram showing the preferred deployment of the input data collector architecture;

FIG. 4 Component Diagram showing the preferred deployment of the processing engine architecture;

FIG. 5 Component Diagram showing the preferred deployment of the publishing interface architecture;

FIG. 6 Use Case Diagram showing main activities of actors Windfarm Owner and Technology Manager;

FIG. 7 Use Case Diagram showing main activities of actors Technology Manager and Researcher; and

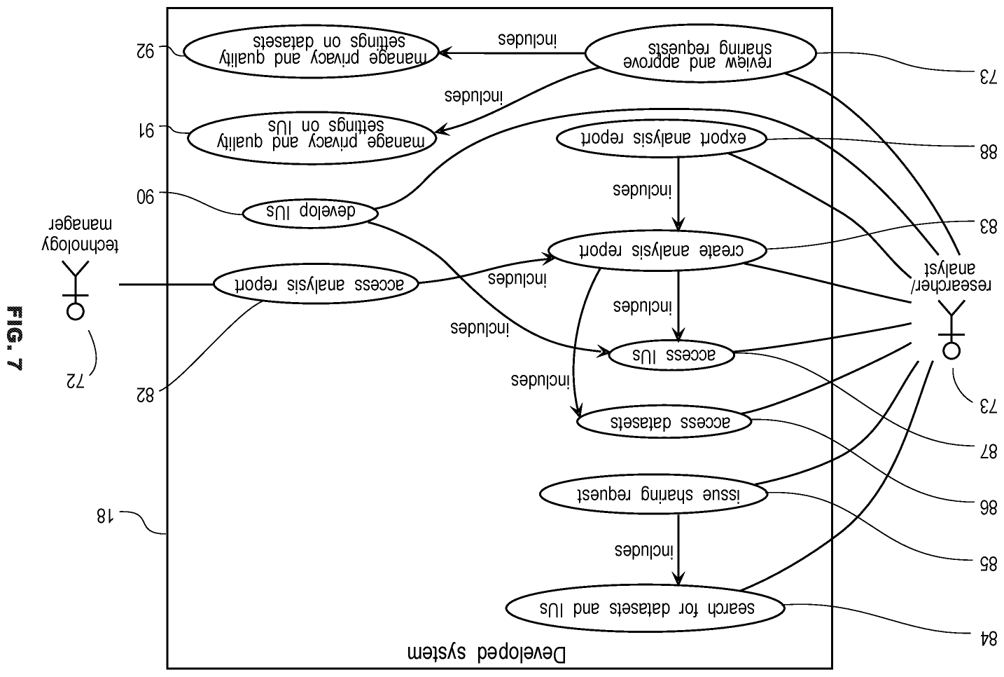

FIG. 8 Class Diagram of main classes (Actor, Intelligence Unit, and Dataset).

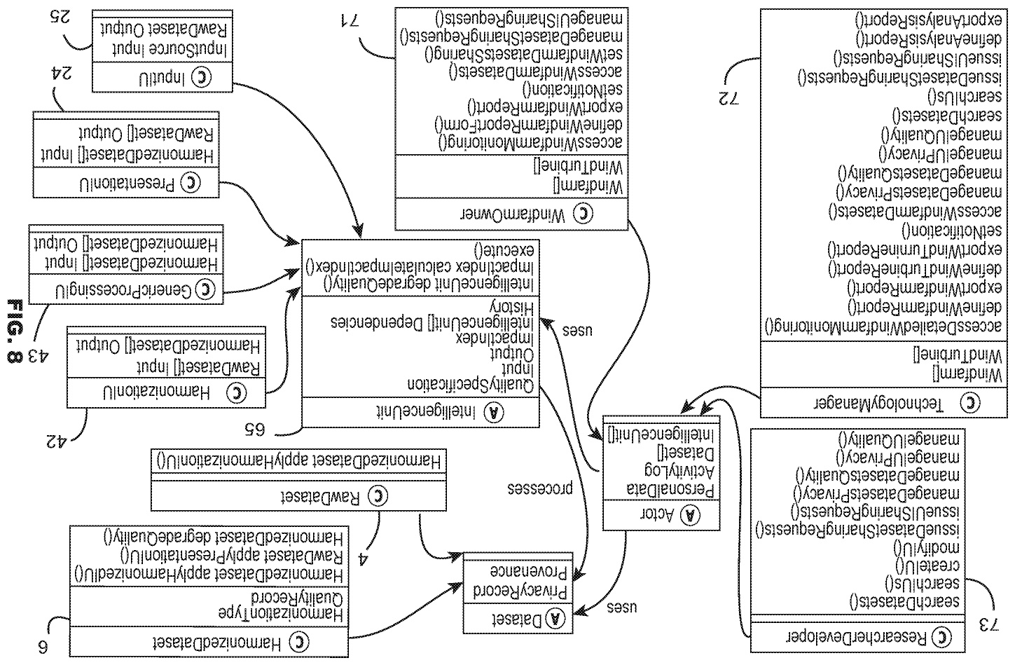

### DETAILED DESCRIPTION AND BEST MODE OF IMPLEMENTATION

The present invention is embodied in an apparatus and a method to allow controlled sharing of information regarding wind farms, wind turbines, controlled sharing of algorithms that process data from wind farms and wind turbines possibly augmented with other contextual data, and controlled sharing of the results of the algorithms that process data from wind farms and wind turbines possibly augmented with other contextual data. The information records that are shared can be either datasets or algorithms. Algorithms managed in the invention can be described and shared in several forms, and if they are expressed in forms directly executable and composable in the invention, they can be managed as functional blocks for description and execution of data processing, and in this form are called hereafter “Intelligence Unit(s)” [65], “IU(s)” for short.

### Data Sharing Management

All the data and data processing algorithms considered in the preferred embodiment are managed with procedures that keep their confidentiality and integrity properties; this extends also to data resulting from processing datasets internally to the system. This is accomplished by augmenting all datasets and processing algorithms with privacy management records [44] and enforcing privacy constraints for each data access and processing.

The information records considered in the preferred embodiment comprise but are not limited to:
1. for wind farms: geographic location, geographic extension, time of operation, environmental conditions, number and model of wind turbines, ownership, ownership kind, time-stamped overall operational parameters;
2. for wind turbines: geographic location, manufacturer, model, time of operation, time-stamped operational parameters, time-stamped SCADA data, historical records of maintenance operations, third party condition monitoring systems and third party sensors data such as data from rotor health monitoring systems, continuous monitoring of vibrations, structural health monitoring systems and custom sensors;
3. algorithms for the processing of data from wind farms and wind turbines, possibly augmented with other contextual data;
4. data deriving from the application of processing algorithms to data from wind farms and wind turbines possibly augmented with contextual data;
5. for each and all of the information records of types I, II, III, IV, a privacy constraints record that in the preferred embodiment specifies at least:
   a) the manager of sharing permissions (named “data-manager”);
   b) the conditions that must be met for the information to be shared with users or groups of users different from the data-manager;
   c) the license that regulates the sharing of information;
d) the cost of the sharing operation.
6. for each and all of the information records of types I, II, III, IV, a quality management record [47] that in the preferred embodiment specifies at least:
   a) the quality levels for the information, in the form it has been inserted into the platform (named “original quality levels”);
   b) for each original quality level, a list of degradation procedures and their related parameters that can be applied to information of said quality level in order to obtain a version with a different (lower) quality level.
   c) for datasets, their Provenance, i.e. the input data source, and the sequence of quality degradation procedures with related parameters and of processing algorithms with related parameters.
   d) for algorithms, their History, i.e. the versioning of their description, the sequence of quality degradation procedures with related parameters and of processing algorithms with related parameters.

In the preferred embodiment, quality level specification for data are:
1. sampling parameters;
2. precision, expressed in terms of standard deviation, inter-quartiles ranges, or other well-defined statistics parameter for dispersion;
3. percentage of unaltered data points;
4. accuracy referred to the original quality level data set;
5. harmonization type;

In the preferred embodiment, quality degradation procedures on data are:
1. enlargement of precision bounds,
2. enlargement of accuracy bounds,
3. increase of sampling period,
4. random deletion of time series points,
5. application of noise that selectively preserves or alters part of the data statistics,
6. user-defined data quality degradation procedures.

In the preferred embodiment, the Provenance of data is automatically collected and stored as a semi-structured log file including all the information necessary to obtain the current data version starting from the raw data as input in the developed system.

In the preferred embodiment, the quality on algorithms information can be expressed in terms of different aspects that contribute to the ease of use, practical applicability, and performance.

In the preferred embodiment, one aspect of the quality specification on algorithms can be expressed in terms of the completeness of the description, including as example:
I. no description at all;
II. a textual description, specifying input and output parameters;
III. a formal description including input parameters and output parameters expressed with the terms and meaning adopted in the platform described in the present invention, and textual description of the processing;
IV. a formal description including input parameters and output parameters expressed with the terms and meaning adopted in the platform described in the present invention, and description of the processing in pseudocode using only control structures, boolean and arithmetic operators, and user defined functions whose description is an algorithm already available in the platform described in the present invention;
V. a complete specification in a programming language, with a formal description of input and output parameters expressed with the terms and meaning adopted in the platform described in the present invention;
VI. an executable version that can be executed on the processing engine [21] into the platform [18] described in the present invention;
VII. an executable version that can be executed as an “External Processing Service” [13] by means external to the platform [18] described in the present invention, with a formal description of input and output parameters expressed with the terms and meaning adopted in the platform described in the present invention, so that the algorithm can be automatically executed from the platform by calling the external processing facility; algorithms with this description quality level are managed as “Intelligence Units” [65];
VIII. an executable version supported by the platform described in the present invention, with a formal description of input and output parameters expressed with the terms and meaning adopted in the platform described in the present invention, so that the algorithm can be automatically run in the platform; algorithms with this description quality level are managed as “Intelligence Units” [65];
IX. a complete specification in a programming language supported by the platform described in the present invention, with a formal description of input and output parameters expressed with the terms and meaning adopted in the platform described in the present invention, so that they can be automatically run in the platform; algorithms with this description quality level are managed as “Intelligence Units” [65];

In the preferred embodiment, one aspect of the quality specification on algorithms can be expressed in terms of the performance achievable in applying the algorithm, including as example:
I. batch processing, best-effort performance, no estimation of completion time;
II. batch processing, best-effort performance, with upfront estimation of completion time;
II. batch processing, with guaranteed completion time;
IV. lossy stream processing (real-time, possible loss of data);
V. lossless stream processing (real-time, guaranteed no loss of data).

In the preferred embodiment, the execution of data processing algorithms can be performed with different means, here and in the following named “processing engines”, each associated with one or more performance quality specification
I. in-platform single-thread execution;
II. in-platform parallel execution;
III. out-of-platform execution;

In the preferred embodiment, the in-platform processing engines are embedded in the platform and are directly used in the algorithms that call the primitives of the programming languages supported in the platform, call library functions supported in the system or request execution of binary programs supported in the platform.

In the preferred embodiment the degradation on algorithms sharing can be applied related to the quality of specification along the different aspects (description, processing engine, performance), including as example:
I. source format->executable binary
II. external processing engine->embedded processing engine
III. parallel version->serial (single-thread) version
IV. high performance->low performance
V. guaranteed performance->estimated performance
VI. estimated performance->no estimation

Licenses for the regulation of the sharing of data and algorithms can be grouped and selected with several criteria; in the preferred embodiment the design goal for the grouping criterion for data-sharing licenses is to provide
1. the data manager with:
   a) a comprehensive list of choices covering the most used licensing schemas;
   b) a pricing criterion associated with the rights granted to the receiver;
2. and both the data manager and the receiver with:
   a) a clear, explicit and simple description of the rights that are granted to the receiver of the data;
   b) a standardized wording of the license terms, possibly adhering to well-known licensing terms and expressions.

In the preferred embodiment the data manager can add new licensing schema, comprising a text describing the conditions under which the information is shared with the receiver, and optionally a cost, that can either be directly specified or be expressed as a function of:
I. information volume;
II. information quality level;
II. cost of processing resources;
IV. cost of memory resources;
V. cost of data transfer procedures;
VI. number of turbines generating the data;
VII. number of turbines potentially affected by results of processing;
VIII. number of wind farms generating the data;
IX. number of wind farms potentially affected by results of processing;
X. additional power produced per turbine as a consequence
XI. the cost of employing other IUs to perform the processing;
XII. values of external factors such as currency conversion fees, cryptocurrencies values, conditions specified as Smart Contracts;
XIII. the cost of another already defined licensing schema.

In the preferred embodiment the available groupings for data sharing licenses are based on:
1. the distinction between “Free” and “Non-Free” cultural work according to the definition by “Creative Commons” (https://creativecommons.org);
2. the extensiveness of rights conceded to the receiver of the data according to the “Open Definition” (http://opendefinition.Org/od/2.1/en/);
3. the 5-star characterization of Linked Open Data https://www.w3.org/Designlssues/LinkedData.html.

In the preferred embodiment the available groupings for algorithm sharing licenses are based on:
1. the distinction between “Open Source” and “Non-Open Source” according to the “Open Source Definition” by the Open Source Initiative (https://opensource.org/osd-annotated)
2. the extensiveness of rights conceded and duties imposed to the receiver according to the Github License characterization (https://choosealicense.com/licenses)

The cost of the sharing operation can be manually specified by the user, automatically calculated on the basis of the information shared, based on the automatically calculated cost multiplied by an user-defined cut rate or rise factor. In the preferred embodiment the calculation for the cost takes into account the type and amount in data points of considered data, the quality degradation method applied, and the license under which the data is shared.

In the preferred embodiment, the History of algorithms is automatically collected and managed by means of version control systems such as Git, adopting a semi-structured format for the comment field in commit and tag objects (or their equivalent in version control systems different from Git).

### Data Processing and Quality Transformation

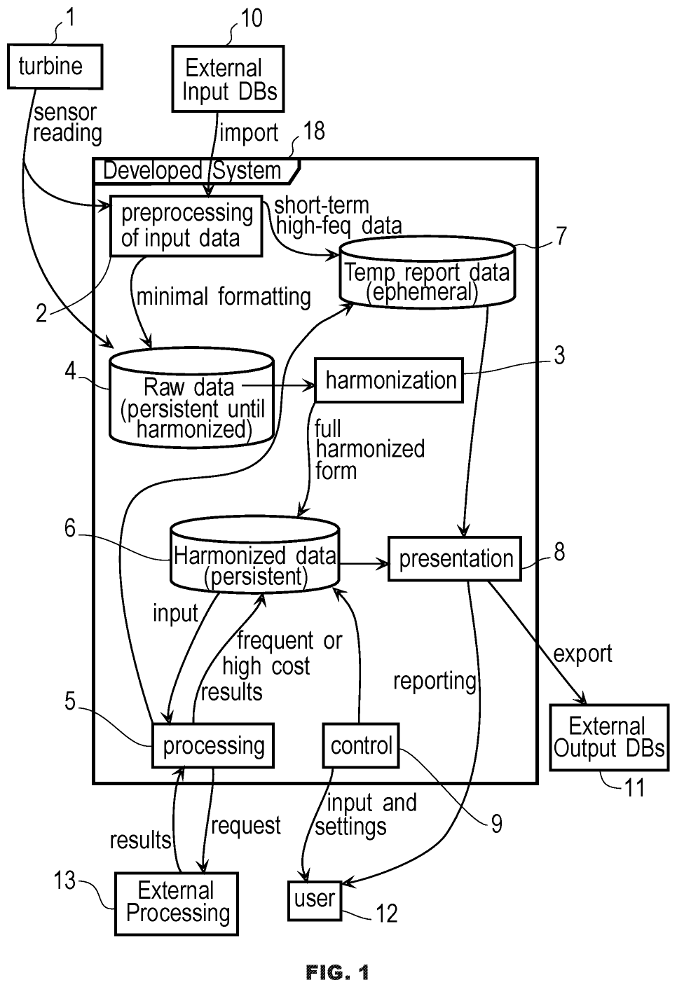

In the preferred embodiment, the main data flow through the system is represented by the Data Flow Diagram in FIG. 1. The entities external to the system are “turbine” [1], representing devices that upload sensor data to the system, “user” [12], representing the human users of the system and “external databases” representing external databases as optional further source of data [10] or as further optional output [11]. Data from sensors [1] or from external databases [10] are preprocessed by the platform [2] procedures that apply minimal required formatting, and are stored in a database dedicated to raw data [4]. The preprocessing [2] procedures also extract a subset of data for quick and short-term monitoring purposes and temporarily store them in ephemeral memory [7]. Raw data [4] is processed by harmonization algorithms [3] and stored in a single harmonized dataset [6]. Data from the harmonized dataset [6] are processed in different ways (e.g. to extract summarization statistics, perform anomaly detection, select turbines or wind farms according to complex performance criteria, etc.) by means of the processing procedures [5]. The results of the processing procedures [5] is stored temporarily in ephemeral memory [7], and if the same results are requested with high frequency, or their computation is costly in terms of computation resources or time, they are also stored in the harmonized dataset [6]. The user performs control operations [9] to: add to the system the descriptions of input sources and information needed to access them; add or modify datasets [6] and processing procedures [5]; apply sharing criteria and constraints for datasets and algorithms; access information by means of the presentation [8] procedures, that process data from the ephemeral dataset [7] and the harmonized dataset [6] to create a easy-to-read and informative report including some or all of figures, tables, graphs and textual descriptions regarding wind turbines and wind farm present in the platform.

In the preferred embodiment, data processing procedures [2] [3] [5] [8] applied to the managed datasets are implemented as pluggable processing modules, that are managed by the system described in this invention as sharing units of algorithmic type, the “Intelligence Unit(s)” [65], “IU(s)” for short. In the description of the invention, we define the “execution” of an IU on a dataset as the application of the data processing procedure described in the IU to a dataset. According to the privacy management records [44] of an IU, the IU is assigned a data manager, that decides how and by whom the IU can be used (shared, viewed, modified, executed, etc). In order to execute an IU on a dataset, an user has to be granted the access permission both to the dataset and the IU, and all the constraints described in the privacy management records [44] of the dataset and the IU are automatically enforced.

Data are provided to the system embodying the present invention by several data providers or input systems [14], that may differ in data format, data submission rate, and other quality properties.

Such data when input in the system by automatic means are preprocessed by Input IUs [25] that perform basic formatting and checks, and store data in the Raw database [4]. In order to let the system process in a similar and automated way data coming from all of the input systems, a procedure called “harmonization” [3] has to be performed, that converts input data in a well-defined form “harmonized form” accepted by the system; data in such form will be referred to as “harmonized data” [6]. If data has not been processed for harmonization, it can be stored in the system in non-harmonized form, and all data processing procedures that apply to harmonized data only will not be available. Even in non-harmonized form, stored data has privacy management records [44] set, and thus can be still managed by the system, albeit with reduced options of choice for the data manager assigned to the dataset. Data that are not in harmonized form are also referred to as “non-harmonized data” and as “raw data”. In the preferred embodiment, harmonization is implemented by means of IUs [42] that operate as follows:
1. accept as input:
   a) non-harmonized data
   b) an identifier of an input source
   c) conversion parameters
2. process non-harmonized data according to the conversion parameters and the identifier of input source
3. produce in output:
   a) harmonized data
   b) harmonization type

All data processing applied to the managed datasets is implemented by means of IUs belonging to different classes according to the harmonization status of the data:
I. input: from out-of-platform data source to stored and accessible non-harmonized data
II. harmonization: non-harmonized-to-harmonized
II. generic processing: harmonized-to-harmonized
   a) quality degradation: changes only data quality level
   b) derived data: changes data, data type, or both
IV. presentation: harmonized-to-out-of-platform/non-harmonized

According to the privacy management records [44] of an IU, the IU is assigned a data manager, that decides how and by whom the IU can be used (shared, viewed, modified, executed, etc). In order to execute an IU on a dataset, an user has to be granted the access permission both to the dataset and the IU, and all the constraints described in the privacy management records [44] of the dataset and the IU are automatically enforced. The result of the execution of an IU of type “generic processing” on a dataset (input dataset) is another dataset (output dataset) whose quality management records [47] and privacy management records are partially or fully defined automatically depending on the privacy management and quality management of the input dataset and of the IU.

In the preferred embodiment, the constraints described in the privacy management records [44] are enforced on data at-rest by means of cryptographic primitives provided by database management systems, and for data in transit by means of end-to-end encrypted protocols. The activities of encryption keys management implied by the enforcement of privacy management records [44] are performed by the “Control and Publishing Interface” component [19].

A class of IU of kind “generic processing” [43] is related with the creation of a statistical model of a dataset, according to a set of selection criteria and providing a statistical description for each of modeled performance parameters.

As an example, such an IU focused on temperatures can have as input
1. a given wind turbine (e.g. as an ID)
2. a time interval
   and will return as output percentiles, extreme values, mean and variance of temperatures of:
1. Gearbox Inlet
2. Gearbox Bearing
3. Rotor Bearing
4. Generator Bearing
5. Converter Inlet

In the preferred embodiment, data are accessed by users by means of multiple client applications [20] or multiple output systems [23] that interact with the “Control and Publishing Interface” module [19] by means of data access interfaces [39] [36]. Each data access interface is implemented by means of a presentation IU [24], i.e. an IU that terminates a processing flow and can not be used as input to other IUs.

In the preferred embodiment, examples of presentation IUs [24] are:
1. data API [39] (with several possible output formats, such as CSV, JSON, ODS, XLS, RDF, XML)
2. publishing API [36] (producing output on different output systems [23], e.g.: Online Social Networks [34] such as Twitter, Facebook, Vkontakt; Instant Messaging applications [33] such as Whatsapp, Telegram, Signal, IRC; VoIP or Video streaming [31] or AudioNideo bulk transfer [40]; email [38], phone call [37], phone text messages [35];)
3. conversational user interface [29]
4. interactive web-based Graphical User Interface [28]
5. interactive character-based command-line interface [27]
6. actuators [32]
7. third party clients [41]

In the preferred embodiment, automatic alerting an notification functions can be created by composing a condition detector IU and a presentation IU [24]; the condition detector IU detects the occurrence of a condition on values of a dataset, and if the condition is verified produces as output a customizable message reporting the type of condition that has been detected and optionally more contextual information or a reference to a more detailed report; the presentation IU [24] takes as input the message generated from the condition detection IU and on the basis of the message publishes it on one or more of the supported channels.

In the preferred embodiment, model construction IUs can be created with generic processing IUs [43] as follows. Given a wind farm (“reference wind farm”) of choice of the system user, comparison with other wind farms can be done on the basis of a subset of operational parameters that can be chosen by the wind farm owner [71]. The selection of the wind farms to compare with can be done with different criteria, that can be expressed as match to a given value or belonging to a given interval of values, and the check of each criterion can be applied as an exact matching or a fuzzy matching; a similarity index is calculated that expresses how close the matching conditions applied and thus how similar the selected wind farm is to the wind farm it is compared with; in the preferred embodiment the selection criteria can be a composition of one or many of the following:
1. terrain conditions
2. time series of weather conditions at a given interval of time
3. size of wind farm in count of turbines
4. size of wind farm in turbines per unit area
5. number of turbines of a given model
6. number of non-planned maintenance events per turbine per unit time
7. type of non-planned maintenance events per turbine per unit time
8. time series of an operational parameter at a given interval of time
9. user selection
   An example of selection is: wind farms that are in similar terrain conditions and of the same size in terms of turbines number, with wind speed time series of 1 h span in the past similar to the last 1 h wind speed time series of the reference wind farm. The monitoring can include comparisons with synthetic wind farms whose data is generated on the basis of a model; in the preferred embodiment the model of the synthetic wind farm is based on both the real wind farm parameters, and a forecast model for operational parameters. In the preferred embodiment the selection process is implemented by an IU of type general process that takes as input the selection criteria and produces as output a list of wind farms.

In the preferred embodiment, complex processing can be performed by composing multiple simpler processing steps, each implemented by a IU.

To better explain how this is performed, in the following we describe complex processing on wind turbine data in terms of composition of IUs. As an example, we consider an IU that computes the gearbox temperature fingerprint of a wind turbine. This IU is implemented as a composition of the following IUs, each hereafter specified at the description quality level II.

IU.1 NAME: Gearbox temperature fingerprint of a wind turbine

INPUT: Wind turbine unique id, time window, amplitude parameter

OUTPUT: normalized temperature mean and standard deviation for each rated power percentage output group

ALGORITHM: cascade of following IUs

IU.1.1 NAME: Fetch all the gearbox bearing temperature data, power output data, and environmental temperature data series within the given time window.

INPUT: Wind turbine unique id, time window

OUTPUT: time series (containing gearbox bearing temperature, power output and environmental temperature.

IU.1.2 NAME: Fetch the nominal rated power value of the given turbine

INPUT: wind turbine unique id

OUTPUT: wind turbine rated power.

IU.1.3 NAME: Extrapolate percentage power time series. Turbine Power Output time series is normalized by the turbine rated power.

INPUT: IU.1.1.OUTPUT (power time series), IU.1.2.OUTPUT (rated power value)

OUTPUT: Percentage of Rated Power output time series

IU.1.4 NAME: Normalize gearbox temperature over the environmental temperature

INPUT: IU.1.1.OUTPUT (gearbox and environmental temperature time series)

OUTPUT: normalized gearbox temperature time series

IU.1.5 NAME: Group all normalized temperature samples on intervals with amplitude of a fixed percentage of the rated power.

INPUT: IU.1.3.OUTPUT and IU.1.4.OUTPUT, amplitude parameter (ex. 10 percent)

OUTPUT: groups of samples from all the time series of the above steps

IU.1.6 NAME: Calculate statistical norm for each of the power percentage groups

INPUT: IU.1.5.OUTPUT (group of samples)

OUTPUT: normalized temperature mean and standard deviation for each rated power percentage output group

To better show IU composition, we consider now another IU, that checks if there is a temperature anomaly on one specific turbine component (such as a gearbox bearing). If an IU has been defined as performing the same processing of the previously described IU “gearbox temperature fingerprint of a wind turbine”, we can use it in the description of the new IU as follows.

IU.2 NAME: Find turbines with temperature anomalies

INPUT: wind farm

OUTPUT: a list of wind turbines with temperature anomalies

IU.2.0 NAME: Select all gearbox models of the turbines in the wind farm

INPUT: wind farm

OUTPUT: list of gearbox models of the wind turbine in given wind farm. For each gearbox model in the output of IU.2.0 perform the following:

IU.2.1 NAME: Select all the turbines in the wind farm with the same gearbox model of the turbine we want to test.

INPUT: IU.2.0.OUTPUT (gearbox model), wind farm

OUTPUT: list of all the turbines unique id with the above characteristic.

IU.2.2 NAME: Gearbox temperature finger print of a wind turbine (applied to all the selected wind turbines)

INPUT: IU.2.1.OUTPUTS (one result for each id), time window, amplitude parameter

OUTPUT: normalized temperature mean and standard deviation for each rated power percentage output group

IU.2.3 NAME: Gearbox temperature finger print of a wind turbine (applied to the wind turbine that we want to test)

INPUT: Test wind turbine unique id, time window, amplitude parameter

OUTPUT: normalized temperature mean and standard deviation for each rated power percentage output group

IU.2.4 NAME: Calculate statistical norm for each rated power percentage output group

INPUT: IU.2.2.OUTPUTS

OUTPUT: wind farm normalized temperature mean and standard deviation for each rated power percentage output group (wind turbine group gearboxes temperature finger print)

IU.2.5 NAME: Test the wind turbine gearbox turbine temperature finger print over the wind turbine group gearboxes temperature finger print

INPUT: IU.2.4.OUTPUT (wind turbine group gearboxes temperature finger prints), IU.2.3.OUTPUT, thresholds.

OUTPUT: boolean, true if the turbine has an anomalous temperature fingerprint

The platform embodying the presented invention provides sharing functionalities that allow further than accessing owned wind turbines and wind farms also to access shared data from third parties' wind turbines and wind farms. This feature allows for example to apply the previously described IU.1 [Select all the turbines in the wind farm with the same gearbox model of the turbine we want to test.] to all the shared turbines with the same gearbox model. This will allow to calculate more accurate and general fingerprints and also to detect gearbox bearing temperature anomalies on a single turbine wind farm where a comparison with the other wind turbines in the same wind farm is not possible.

The platform embodying the presented invention provides an evaluation function that generates for all the Intelligence Units [65] an estimation of the impact that the usage of the IU can have on the operation of a given wind turbine or on a given wind farm in terms of availability, produced energy, time between faults, servicing times, management costs. Such impact can be represented in terms of one or more of the previous parameters or analogous operational parameters, that can be summarized in one or more synthetic values, collectively referred to as “impact index”.

The calculation of the “impact index” is performed on a list of parameters including but not limited to all or a subset of the following:
I. datasets available in the platform (including characteristics of the wind turbine, of other wind turbines of same model or with analogous behavior, and characteristics of the wind farm site)
II. third-party datasets
II. the difference in datasets between time periods preceding and following the adoption of the IU for control or decisions support

When a IU [65] is applied to a dataset, the associated “impact index” is automatically calculated, and made available to the user as a characteristic of that IU applied to that dataset. Before an IU is applied to a dataset, the “impact index” can be applied to a default dataset to provide a reference.

IUs [65] and datasets can be presented to the user as a suggestion for adoption based on the “impact index” they have, calculated on wind turbines or wind farms accessible to the user or that can request the access to.

In the preferred embodiment, the algorithm that calculates the “impact index” is implemented as an Intelligent Unit [65] itself, and is associated with the IUs [65] it can be applied to by the Researcher/Developer [73].

### Users Interaction

In the preferred embodiment, the interactions of users with the system for purposes of control and information access can be performed by means of multiple interfaces and in different forms including but not limited to:
1. interactive web-based Graphical User Interface [28]
2. programmable web-based API [36] [39]
3. interactive, vocal, text, conversational [29] or haptic interface
4. programmable command-line interface [27]
5. desktop client application (multi-platform supporting Linux, MacOSX, Windows)
6. mobile client application (multi-platform supporting Android, iOS, Windows Mobile) [30]

The system described in the present invention offers services to different types of customers.

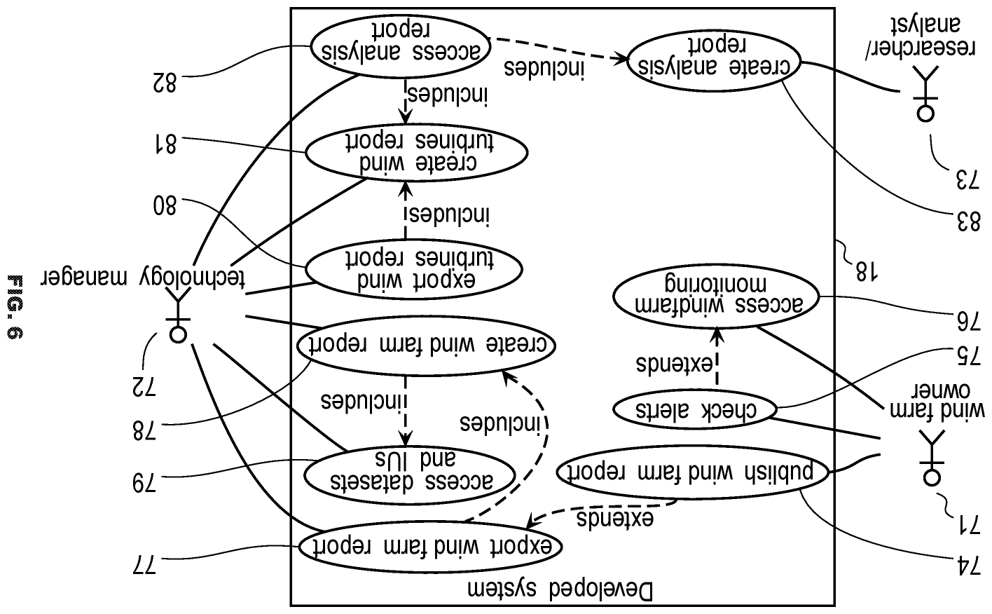

To describe the interactions between the customers and the system hereafter we refer to each customer kind as “actors” in the sense used in UML modeling for software systems. Therefore an “actor” in the following will represent one or a group of customers that interact with the system performing a common set of operations. An actual user of the described system can be represented by one or more of the following actors, according to the interactions they have with the system, e.g. a Technology Manager of a wind farm is usually interested in the detailed technical conditions of turbines, but occasionally may want to produce a synthetic document describing the overall performance of the whole wind farm. In the preferred embodiment, the main actors are
1. wind farm Owner [71] (“WO” for short), representing a wind farm owner and more in general a stakeholder mainly interested in high-level managing aspects of the wind farm, in need of overall informations to help decision making;
2. Technology Manager [72] (“TM” for short), representing a wind farm technology manager and more in general a stakeholder interested in the detailed information about technical aspects of the wind farm, the wind turbines and the subsystems and components of the wind turbines, and the subsystems and processes of the wind farm;
3. Researcher/Developer [73] (“RD” for short), representing researchers, data analysts, engineers and technicians, with basic skills in programming and expertise in one or more fields related to wind energy, including but not restricted to: data processing, statistics, mechanics of wind turbines, economics of wind farms, physics, topography, geomorphology, environmental engineering.
   WO [71] performs the subsequent main actions:
1. monitors the overall operational conditions of the wind farms under his control, summarized in one or more of dashboards, reports, and interfaces, for each wind farm or for all wind farms under his interest, depicted as “access wind farm monitoring” [76] in FIG. 6; the monitoring can include comparisons with wind farms not directly under control of the WO and that have shared with them wind farm datasets, possibly at a degraded quality level;
2. defines the structure of the dashboards and or report documents and or interfaces [74], depicted as “wind farm report” in FIG. 6, describing a subset or all of the wind farms under their control in terms of a selection of operational parameters, over a given time span; the typical usage for this document is to provide a feedback to stakeholders, for economic planning and accounting, publicity;
3. consults and exports [77] updated versions of the “wind farm report”;
4. sets alerts and or notifications based on continuously updated datasets [75] (e.g. operational parameters of a wind farm), in order to be alerted with one or more of the available messaging methods supported in the platform, when a specified condition verifies on the updated dataset;
5. accesses their own assigned datasets and all the shared data, mostly regarding overall wind farm properties and performance parameters [76];
6. in doing all of the above actions, uses IUs assigned to them, mostly of type “presentation” [24]
7. sets cost calculation criteria and general sharing conditions for datasets and IUs that they own
8. reviews and approves sharing requests for datasets and IUs that they own
9. reviews and approves sharing requests for datasets and IUs to be acquired.
   TM [72] performs the subsequent main actions:
1. monitors the detailed operational conditions of the turbines and the wind farms under their control, summarized in at least one of dashboards, report documents, and interfaces, for each turbine or for all turbines and wind farms under their control, named as “detailed wind farm monitoring” and being an extension of “create wind farm report” [78] activity in FIG. 6; the monitoring can include comparisons with turbines and wind farms not directly under control of the TM [72] and whose datasets have been shared with the TM [72], possibly at a degraded quality level;
2. defines the structure, create [78], export [77] report documents, depicted as “wind turbine report” in FIG. 6, describing a subset or all of the wind turbines of one or more wind farms under their control in terms of a selection of operational parameters, over a given time span; the typical usage for this document is to provide a feedback to technicians, engineers, consultants, researches, for maintenance planning, performance analysis and modeling;
3. consults, create [81] and exports [80] updated versions of the “wind turbine report”;
4. sets alerts and notifications based on continuously updated datasets (e.g. operational parameters of turbines), in order to be alerted with one or more of the available messaging methods supported in the platform, when a specified condition verifies on the updated dataset;
5. accesses their own assigned datasets and all the shared data, mostly regarding overall wind farm properties and performance parameters [79] [86];
6. in doing all of the above actions, uses IUs assigned to them or develops new IUs [79] [90], mainly by means of composition of already available IUs;
7. manages privacy [44] and quality records [47] for their datasets [92] and IUs [91] searches for datasets and IUs owned by other users [84];
8. issues sharing requests for datasets and IUs to be acquired [85].

RD [73] performs the subsequent main actions:
1. searches for datasets and IUs owned by other users [84];
2. issues sharing requests for datasets and IUs [85] to be acquired.
3. accesses the datasets and IUs [79] shared with them or created by them;
4. develops new IUs [90], composing, modifying or inserting in the system from scratch the description of the processing algorithms;
5. manages privacy [44] and quality records [47] for their datasets [92] and IUs [91]
6. reviews and approves sharing requests for datasets and IUs that they own [89]
7. defines the structure of report documents, named as “analysis report” [83], describing a subset or all of the wind turbines of one or more wind farms under their control in terms of a selection of operational parameters, over a given time span; the typical usage for this document is to present analyses on datasets, to be published in technical reports, or specialized magazines and journals, or presented at conferences;
8. consults [82] and exports [88] updated versions of the “analysis report” document;

### Preferred Deployment

In the preferred embodiment, some of the components of the system [18] are deployed as nodes in a cloud computing system, in order to benefit from scalability, availability, and cost effectiveness of these services. With reference to FIG., the components “Input Data Collector” [17], “Processing Engine” [21] and “Control and Publishing Interface” [19] are deployed on one or more nodes of a cloud computing service according to the “Infrastructure as a Service” (IaaS) paradigm; the database components [22] are deployed as cloud storage services (as Software as a Service, SaaS) or implemented in database management systems on IaaS service nodes like previous components. Client applications [20] are implemented as stand alone applications.

In alternative implementations, according to the privacy, control and cost requirements, some of the components of the system [18] are deployed on premises, in servers completely managed by the client.

In alternative implementations, according to the privacy, control and cost requirements, some of the databases [22] are distributed, allowing storage and replication of data on multiple instances that can be geographically distributed.

The use of distributed databases [22] and the possibility of composing IUs [65] in execution on different Processing Engines [21] allows also hybrid deployments, with part of IUs [65] executed on-premises, on data from local or remote databases [22], and part of IUs [65] executed in cloud computing systems.

A typical use case for a hybrid deployment is when data sources [16] produce high-frequency data, whose transmission to the “Input Data Collector” [17] would be expensive or not possible with the existing infrastructure. In such cases one or more instances of the “Input Data Collector” [17], “Processing Engine” [21], and “databases” [22] are to be deployed where the high-frequency data are produced, i.e. on-premises in the wind farm or in the wind turbine itself.

In order to adapt the actual deployment to the specific needs of the client, a design requirement is to use Open Source Software for every component where available, and use proprietary software only in case of lack of suitable alternative.

In the preferred embodiment, the software components of the system [18] are developed as integration, modification and extension of publicly available Open Source Software products.

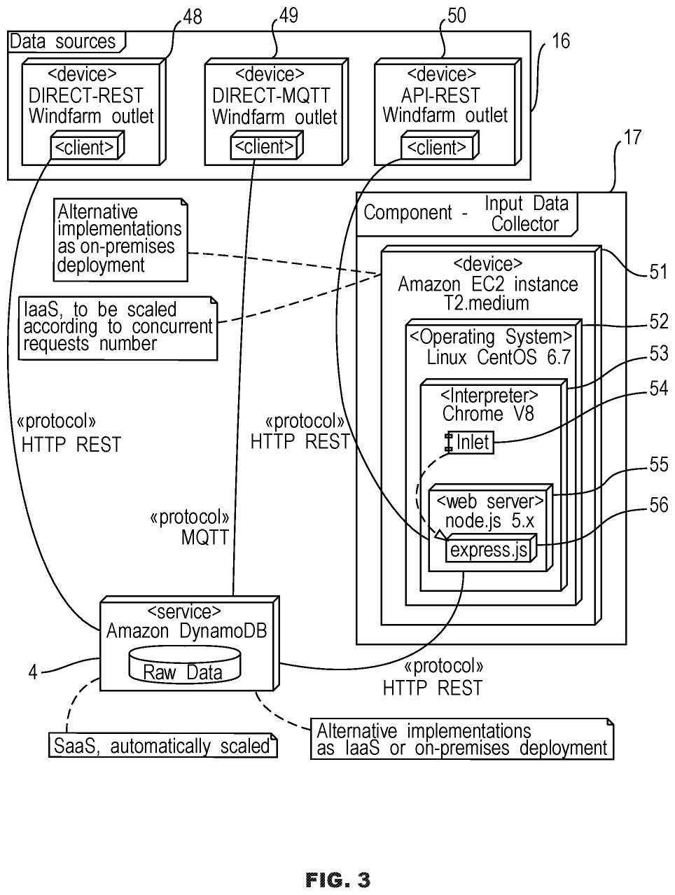

The “Input Data Collector” component [17] receives data by several input data sources [16] and and saves it to the “Raw Data” database [4]. Input data sources [16] are subsystems external to the developed systems that collect data from sensors and transfer them to Input Data Collector by means of the Input Data Collector API or directly to the “Raw Data” database [4]. In the preferred embodiment, the “Input Data Collector” component [17] is implemented as one or more instances of a node.js server [55] running in an IaaS cloud service based on the Chrome's V8 Javascript engine [53] and connected to a NoSQL cloud database service, “Raw Data” [4]. The input data sources [16] such as sensors on one or more wind turbines can upload data to the developed system [18] with different means, and are implemented as, and not limited to
“Direct-REST wind farm outlet” [48] if they directly submit data to the “Raw Data” database [4] using a HTTP REST protocol;
“Direct-MQTT wind farm outlet” [49] if they directly submit data to the “Raw Data” database [4] using the MQTT protocol or equivalent database service data manipulation protocol;
“API-REST wind farm outlet” [50] if they send the data to the “Input Data Collector” component using an HTTP REST protocol for preprocessing [2] and storing in “Raw Data” database [4].
   Any of the input data sources [16] such as sensors on one or more wind turbines can either directly upload data to the “Raw Data” database [4], or send the data to the “Input Data Collector” component for preprocessing [2] and storing in “Raw Data” database [4]. The choice of the specific IaaS service will depend on the available offer at the time of the operations, and a prototype implementation has been done with “Amazon EC2” instance of type “T2. medium” [51] running the operating system Linux CentOS 6.7 [52]. Alternative implementations can be considered using the equivalent of performance of a server with 2 CPU Intel Xeon Processors with Turbo up to 3.3 GHz, 4 GiB RAM and 100 GiB Hard Disk with 160 MiB/s peak throughput. In the preferred embodiment, the NoSQL database is implemented as a SaaS service “Amazon DynamoDB”, that can be accessed both by means of MQTT protocol and by a RESTful API. An UML Deployment Diagram of this component is depicted in FIG. 3.

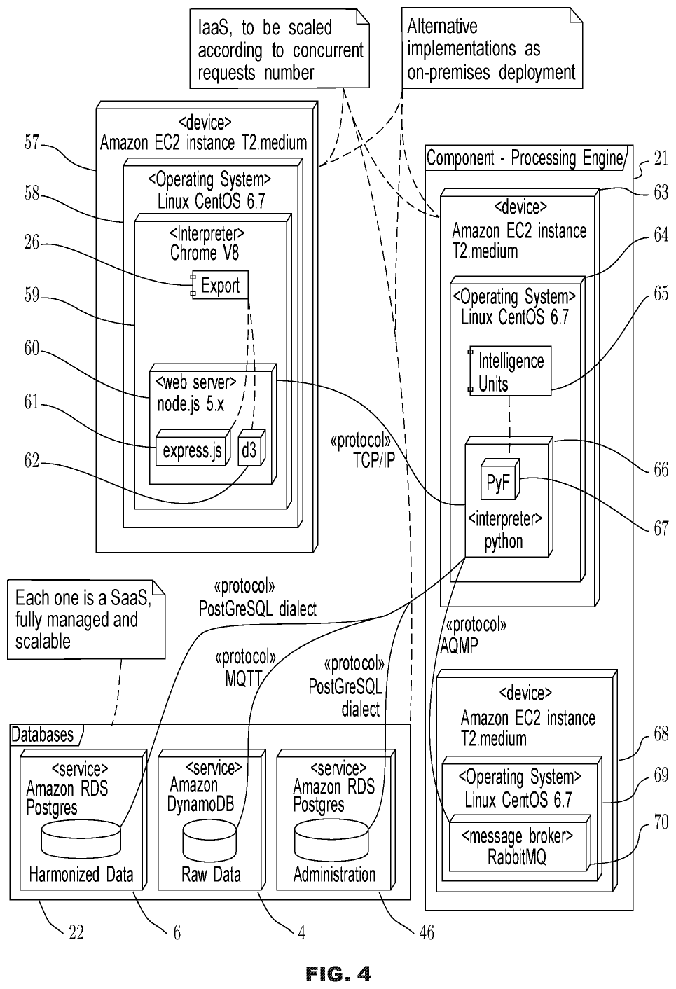

The “Processing Engine” component [21] performs processing [5] on the datasets according to the specification of the users, including the harmonization of data and the quality degradation of data. In the preferred embodiment, the data processing activities are specified as a workflow, i.e. as a sequence of processing steps (“tasks”) where the output of one or more tasks is the input of one or more subsequent tasks. Such workflow is managed as an “Intelligence Unit” [65] that is associated with privacy management metadata, hold in the “Administration” database [46]. In the preferred embodiment, the “Processing Engine” component [21] is implemented as one or more instances of a node.js server running in an IaaS cloud service, each of such instance able to run one or more tasks. In the preferred embodiment, the composition and synchronization of tasks is implemented by means of the flow programming engine PyF [67] written in Python [66]. Alternate implementations can be considered for the composition of tasks using cloud services such as flowhub.io. The communication aspects of tasks orchestration and task assignment to the instances is performed by means of a message broker [70] that implements work queues. In the preferred embodiment, the message broker is implemented as RabbitMQ server and a prototype implementation has been done with “Amazon EC2” instance of type “C2. medium” [68] running the operating system Linux CentOS 6.7 [69]. The “Processing Engine” component [21] is connected to all databases of the platform [22], specifically the “Administration” database [46], the “Raw Data” database [4], and the “Harmonized Data” database [6]. The “Processing Engine” component [21] can connect also to external databases for import [10] or export [11] of datasets. The choice of the specific IaaS service will depend on the available offer at the time of the operations, and a prototype implementation has been done with “Amazon EC2” instance of type “C4. large” [63] running the operating system Linux CentOS 6.7 [64]. In cloud-based implementations the number of instances concurrently processing the tasks will be dynamically determined according to the current load of the system, leveraging the elasticity features of the cloud service. To match the processing demands, the elasticity of the IaaS service can be leveraged either scaling horizontally (activating more identical instances) or vertically (incrementing the number of virtual CPUs available on instances). Alternative implementations can be considered using the equivalent of performance of a server with 2 CPU Intel Xeon Processors with Turbo up to 3.3 GHz, 4 GiB RAM and 100 GiB Hard Disk with 500 MiB/s peak throughput. In case on-premises implementations will be considered, a computing cluster setup is adopted, where a maximum number of instances concurrently processing tasks will be determined according to the planned user base. An UML Deployment Diagram of this component is depicted in FIG. 4.

The “Control and Publishing Interface” component [19] presents a control interface to the users, and brokers all the interactions of users with the platform. The “Control and Publishing Interface” component [19] is implemented as a rich web application, composed of a web client (browser) and a server part. In the preferred embodiment, the web client is a browser supporting JavaScript language, according to ECMAScript specification ECMA-2623rd edition. In the preferred embodiment, the server side of the “Control and Publishing Interface” component [19] is implemented as one or more instances of a node.js server [60] interpreted by the Chrome's V8 Javascript engine [59] and running in an IaaS cloud service.

The “Control and Publishing Interface” component [19] is connected to the “Administration” database [46], to perform management of users authentication, authorization and accounting [45], and management of dataset privacy management metadata [44] and quality management metadata [47]. The “Control and Publishing Interface” component [19] is connected to the “Processing Engine” component [21], to which it requires execution of “Intelligence Unit” [65] processing that will result in data visualization or reports. The “Control and Publishing Interface” component [19] is connected to external publishing services, such as Online Social Networks [34], email servers [38], instant messaging services [33] and telephone networks [37]. The communications with those external publishing services is performed using the respective APIs, managed by the PublishingAPI interface [36]. The “Control and Publishing Interface” component [19] is connected to the client applications [20] providing access to the developed platform services by means of the Data API [39]. Both the Data API [39] and the Publishing API [36] are implemented in the “Export” module [26].

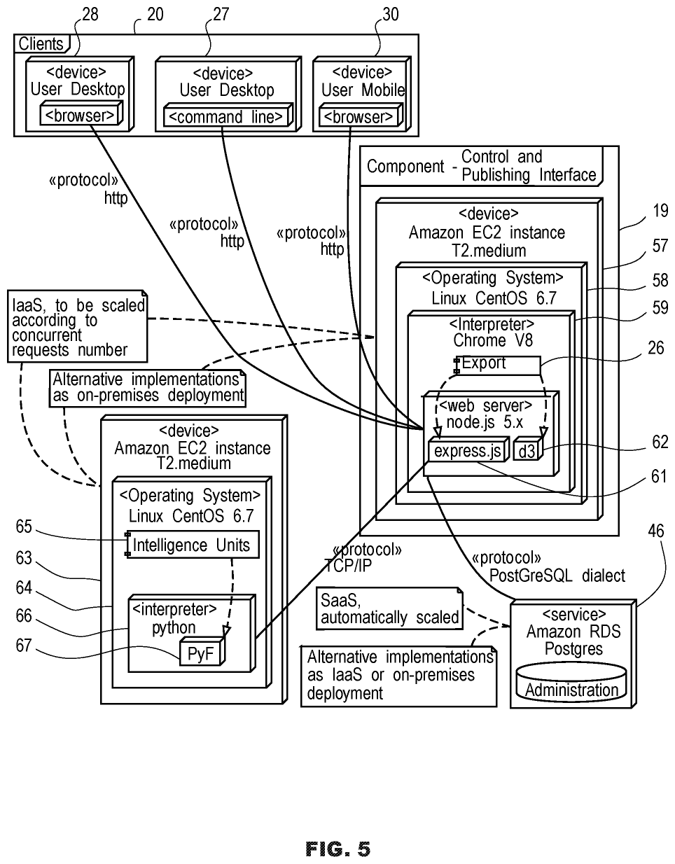

In the preferred embodiment, the “Export” module is implemented by means of the “express.js” [61] and “d3” [62] frameworks. The choice of the specific IaaS service to implement this component will depend on the available offer at the time of the operations, and a prototype implementation has been done with “Amazon EC2” instance of type “T2. medium” [57] running the operating system Linux CentOS 6.7 [58]. Alternative implementations can be considered using the equivalent of performance of a server with 2 CPU Intel Xeon Processors with Turbo up to 3.3 GHz, 4 GiB RAM and 100 GiB Hard Disk with 160 MiB/s peak throughput. In cloud-based implementations the number of instances concurrently serving user requests will be dynamically determined according to the current load of the system, leveraging the elasticity features of the cloud service. In case on-premises implementations will be considered, a computing cluster setup is adopted, where a maximum number of instances concurrently serving user requests will be determined according to the planned user base. An UML Deployment Diagram of this component is depicted in FIG. 5.

In alternative implementations, part or all the activities for the enforcement of the business rules and policies can be implemented with blockchain technologies such as Ethereum Smart Contracts.

In alternative implementations, part or all the data storage and access can be implemented on distributed ledgers with blockchain technologies.

The platform embodying the presented invention provides sharing functionalities that allow further than accessing owned wind turbines and windfarms also to access shared data from third parties' wind turbines and windfarms. This feature allows for example to apply the previously described IU.1 [Select all the turbines in the windfarm with the same gearbox model of the turbine we want to test.] to all the shared turbines with the same gearbox model. This will allow to cal-culate more accurate and general fingerprints and also to detect gearbox bearing temperature anomalies on a single turbine windfarm where a comparison with the other wind turbines in the same wind farm is not possible.

The platform embodying the presented invention provides an evaluation function that generates for all the Intelligence Units [65] an estimation of the impact that the usage of the IU can have on the operation of a given wind turbine or on a given windfarm in terms of availability, produced energy, time between faults, servicing times, management costs. Such impact can be represented in terms of one or more of the previous parameters or analogous operational parameters, that can be summarized in one or more synthetic values, collectively referred to as “impact index”.

The calculation of the “impact index” is performed on a list of parameters including but not limited to all or a subset of the following:
I. datasets available in the platform (including characteristics of the wind turbine, of other wind turbines of same model or with analogous behavior, and characteristics of the windfarm site)
II. third-party datasets
II. the difference in datasets between time periods preceding and following the adoption of the IU for control or decisions support

IUs and datasets can be presented to the user as a suggestion for adoption based on the “impact index” they have, calculated on wind turbines or wind farms accessible to the user.

1. A method for controlled sharing of data, data analysis algorithms, and results of data analysis regarding one or a plurality of wind turbines and wind farms, and controlled access to said data, data analysis algorithms, and results of data analysis, comprising the following steps:
a) provision of sensor means for reading data relating to the operation of each wind turbine, respectively of each wind farm, of said plurality of wind turbines, respectively of wind farms, for monitoring the operating data of the wind turbines of said plurality of wind turbines, respectively of wind farms;
b) provision of data storage and management means, to store and provide controlled access to data of the wind turbines of said plurality of wind turbines, respectively of wind farms;
c) connection via point-to-point links or telecommunication network of said sensor means to said data storage and management means;
d) provision of processing and calculation means, connected with point-to-point links or telecommunication network to said data storage and management means and configured for collecting, storing, and processing of the operating data of the wind turbines of said plurality of wind turbines, respectively of wind farms;
e) provision of processing and control means, to manage data, and metadata, and brokering of all the interactions of users with the system implementing the proposed method; connected with respect to the said telecommunication networks;
f) connection through a telecommunication network of a plurality of users for the sharing among them of the operating data of the wind turbines of said plurality of wind turbines, respectively of wind farms, and algorithms for processing said data;
g) collection and storage of data derived from or related to sensors readings on wind turbines, wind farms, related devices and surroundings; h) execution of modular shareable data processing procedures that transform input data into a single harmonized format;
h) execution of modular shareable data processing procedures that transform input data into a single harmonized format;
i) execution of modular shareable procedures that process harmonized data to extract information regarding the operational conditions of the wind turbines or the wind farm;
j) storage in form of harmonized data of the results of the execution of the modular shareable procedures on harmonized data;
k) interaction with users of the system to allow the addition of input sources, datasets, and processing procedures (algorithms);
l) execution of procedures to apply sharing criteria and constraints for datasets and processing procedures (algorithms) among different users of the system, optionally involving the execution of quality degradation procedures on datasets and algorithms to create the shared form of datasets and algorithms;
m) execution of modular shareable procedures that process harmonized data to create a report of information extracted from harmonized data;
n) interaction with users of the system to allow controlled access to datasets and processing procedures, and the sharing criteria for datasets and processing procedures (algorithms).

2. A method as in claim 1, where data and results of data processing can trigger alarms, issue notifications, and command actuators.

3. A method as in claim 2, where actuators are on a wind turbine.

4. A method as in claim 1 where processing algorithms are suggested to the users on the basis of information related to their associated wind farms, the related datasets, and the availability of other processing algorithms and datasets.

5. A method as in claim 4 where the suggestion includes or is based on the estimate of potential economic savings or gains from wind farm operations.

6. A method as in claim 5 where the estimate of potential economic savings or gains from wind farm operations is calculated based on historical data of wind farms before and after the adoption of a data processing algorithm.

7. A method as in claim 1 where part or all the developed system is deployed inside a wind turbine.

8. A method as in claim 1 where part or all the developed system is deployed inside a wind farm.

9. A method as in claim 1 where part or all the control and policy enforcement activities are implemented with blockchain technologies.

10. A method as in claim 1 where part or all the data storage and management activities are implemented on a distributed ledger with blockchain technologies.

11. A method as in claim 1, where data are derived from sensors on solar or photovoltaic plants or on run-of-river hydro power plants or on biomass power plants or on diesel, gasoline, biogas, alternative and custom fuels generators or on electric utility grids or on microturbines or on fuel cells.

12. A method as in claim 1, where data are derived from sensors on energy storage plants or machinery such as flywheels or battery bank or flow batteries or hydrogen plants.

13. A method as in claim 1, where data are associated with specifications of sharing criteria, processing algorithms, sharing criteria for processing algorithms and data.

14. A method as in claim 1, where data are associated with sharing criteria including specifications of quality degradation algorithms.

15. A method as in claim 1, where data are input in the system from databases, regardless of the input method.

16. A method as in claim 1, where data and results of data processing are accessed by means of interactive, vocal, text, conversational or haptic interface.

17. A method as in claim 1, where control of the system can be performed by means of interactive, vocal, text, conversational, or haptic interface.

18. A method as in claim 1, where accessed data regard wind farms or wind turbines of different tenants.

19. A method as in claim 1, where accessed data regard plants or technologies of different tenants.

20. A method as in claim 1, where the data access is granted according to the sharing specifications set by the data owners.

21. A method as in claim 1, where data processing algorithms described in are directly executable in the system.

22. A method as in claim 1, where algorithms are composable and can be managed as functional blocks.

23. A method as in claim 1, where one or more components of the system are implemented by means of Cloud Computing services.

24. (canceled)
